(19) United States
(12) Patent Application Publication
(10) Pub. No.: US 2023/0124811 A1
(43) Pub. Date: Apr. 20, 2023

(54) MANUFACTURER USAGE DESCRIPTIONS FOR LIGHTWEIGHT MACHINE TO MACHINE PROTOCOLS

(71) Applicant: Telefonaktiebolaget LM Ericsson (publ), Stockholm (SE)

(72) Inventor: Jaime Jiménez, ESPOO (FI)

(21) Appl. No.: 17/909,200

(22) PCT Filed: Apr. 22, 2020
(86) PCT No.: PCT/SE2020/050407

§ 371 Date: Sep. 2, 2022

Related U.S. Application Data
(60) Provisional application No. 62/985,614, filed on Mar. 5, 2020.

(51) Int. Cl. H04W 12/086; G16Y 10/75; G16Y 30/10

(52) U.S. Cl. CPC H04W 12/086; G16Y 10/75; G16Y 30/10

(57) ABSTRACT

A method by an IoT device includes hosting a MUD file and local memory of the IoT device, and exposing content of the MUD file from the local memory of IoT device is a CoAP resource. A related method by a MUD manager includes receiving using CoAP from an IoT device a URL advertising location of a MUD file stored in local memory of the IoT device, and getting content of the MUD file from the local memory of the IoT device using CoAP. A related method by a LwM2M server includes receiving a registration command from a LwM2M client for an IoT device using CoAP. determining a policy to be used to control communications with the IoT device, determining content of a MUD file based on the policy that is determined, and providing the content of the MUD file to the LwM2M client for the IoT device using CoAP.

### TECHNICAL FIELD

The present disclosure relates to Internet-of-Things (IoT) devices, and in particular to using Manufacturer Usage Description (MUD) files with Internet-of-Things Devices.

### BACKGROUND

The Constrained Application Protocol (CoAP) is a specialized web transfer protocol, Representational State Transfer (REST)-based application-layer protocol, for devices with constraints on system resources such as processing power and memory size. CoAP (Internet Engineering Task Force (IETF) Request for Comments (RFC) 7252, June 2014) is designed to be used over User Datagram Protocol (UDP) over the Internet.

On current deployments, CoAP-based solutions like Open Mobile Alliance (OMA) Lightweight Machine to Machine (LwM2M) are becoming increasingly popular for managing devices in a REST-based fashion.

Manufacturer Usage Descriptions (MUD) (RFC8520, March 2019) are used to advertise to the network the best, e.g. preferred or operationally constrained, configuration for an Internet-of-Things (IoT) device. MUDs are composed of a URL that is advertised, the URL can be used to locate a MUD description. One purpose of MUD is to provide a way for end devices to signal to the network what sort of access and network functionality they require to properly function. The MUD may advertise device specifications, including the intended communication patterns for the device when it connects to the network. The network may then use this intent to author a context-specific access policy, so the device functions only within those parameters. In this manner, MUD becomes the authoritative identifier and enforcer of policy for devices on the network.

The term “manufacturer” generally refers to the entity or organization that will state how a device is intended to be used. For example, in the context of a light bulb, this might be the light bulb manufacturer. In the context of a smarter device that has a built in Linux stack, it might be an integrator of that device. The key points are that the device itself is assumed to serve a limited purpose, and that there exists an organization in the supply chain of that device that will take responsibility for informing the network about that purpose.

MUDs are used to provide a means for end devices (IoT devices) to signal to the network what sort of access and network functionality they require to properly function. In a MUD scenario, the “IoT device” exposes a “MUD URL” to someone, a “MUD Processor” queries a “MUD file server” and retrieves the “MUD File” from it. After processing the “MUD processor” applies an “Access Policy” to the IoT device. The IoT device is also interchangeably referred to herein as a “device”, “Thing”, and “IoT Thing.”

The configuration of MUD may provide any one or more of the following:
Substantially reduce the threat surface on a device to those communications intended by the manufacturer.
Provide a means to scale network policies to the ever-increasing number of types of devices in the network.
Provide a means to address at least some vulnerabilities in a way that is faster than the time it might take to update systems. This will be particularly true for systems that are no longer supported. Keep the cost of implementation of such a system to a minimum.
Provide a means of extensibility for manufacturers to express other device capabilities or requirements.

The following terms used when referring to FIGS. 1A and 1B may be defined as follows:
MUD file: a file containing YANG-based JSON that describes an IoT device and associated suggested specific network behavior.
MUD file server: a web server that hosts a MUD file.
MUD manager: the system that requests and receives the MUD file from the
MUD server. After it has processed a MUD file: can contain information directing changes to relevant network elements.
MUD controller: a synonym for MUD manager
MUD URL: a URL that can be used by the MUD manager to receive the MUD file.
IoT device: the electronic device emitting a MUD URL.
Manufacturer: the entity that configures the IoT device to emit the MUD URL and the one who asserts a recommendation in a MUD file. The manufacturer might not always be the entity that constructs an IoT device. It could, for instance, be a systems integrator, or even a component provider.

As shown in FIG. 1A, a MUD architecture can include an IoT device, a MUD Manager, and a MUD file server. FIG. 1B illustrates an example MUD process flow. Referring to FIG. 1B, the IoT device sends a MUD URL to the MUD manager. When an IoT device first connects to a router or switch, e.g., Network Access Point, it may send (step 1) a MUD URL embedded in either the LLDP, DHCP, or 802.1X request. The router or switch, e.g., Network Access Point, extracts the URL, encapsulates it in a Radius packet, and sends (step 2) it to the AAA Server. When the MUD URL is embedded in a DHCP packet, some networks may instead forward the entire DHCP packet to the AAA Server.

The AAA Server then passes (step 3) this URL onto the MUD Manager. The MUD Manager then contacts (step 4) the internet hosted MUD File Server of the manufacturer that this URL points to over HTTPS. After the MUD file server verifies that the MUD file was produced by the device manufacturer, the MUD file corresponding to that device is sent (step 5) by the MUD file server to the MUD Manager. This MUD file, which may be a YANG Data Model represented as a JSON object, contains abstracted communication intent for the IoT device in question.

The MUD Manager translates this abstract intent to a context-specific policy, which is passed (step 6) onto the AAA Server/Identity Service Engine (ISE). The ISE then enforces (step 7) the policy onto the network in the form of port-based Access Control Lists (ACLs) for the point of that IoT device's connection.

Based on the manufacturer stated intent, access (step 8) to the device is then provided.

A MUD process can be used to automatically permit the device to send and receive only the traffic it requires to perform its intended function. A MUD process can also be used to palliate distributed denial-of-service (DDoS) attacks, for example by prohibiting unauthorized traffic to and from IoT devices. Even if an IoT device becomes compromised, content of a MUD file can prevent the IoT device from being used in any attack that would require the IoT device to send traffic to an unauthorized destination.

A MUD process is not intended to address network authorization of general-purpose computers but of IoT devices. However, MUD URLS are currently mandated in the “https” scheme (RFC7230, June 2014).

### SUMMARY

Some embodiments of the present disclosure are directed to a method by an IoT device. The method includes hosting a MUD file and local memory of the IoT device, and exposing content of the MUD file from the local memory of IoT device is a CoAP resource.

Some other related embodiments are directed to a method by a MUD manager. The method includes receiving using CoAP from an IoT device a URL advertising location of a MUD file stored in local memory of the IoT device. The method further includes getting content of the MUD file from the local memory of the IoT device using CoAP.

Some other related embodiments are directed to a method by a LwM2M server. The method includes receiving a registration command from a LwM2M client for an IoT device using CoAP. The method determines a policy to be used to control communications with the IoT device, and determines content of a MUD file based on the policy that is determined. The method then provides the content of the MUD file to the LwM2M client for the IoT device using CoAP.

Some other related embodiments are directed to a method by a Resource Directory (RD) server. The method includes receiving a command from an Internet of Things, IoT, device to register a URL for a MUD file stored in local memory of the IoT device. The method stores the URL as a MUD based resource type in an object structure maintained by the RD server. The method responds to a query from an electronic device identifying the MUD based resource type by providing the URL to the electronic device.

Some other embodiments are directed to a corresponding IoT device that includes at least one processor, and at least one memory coupled to the at least one processor and which includes computer readable program code that when executed by the at least one processor causes the at least one processor to perform operations. The operations are configured to host a MUD file in local memory of the IoT device, and to expose content of the MUD file from the local memory of the IoT device as a CoAP resource.

Some other embodiments are directed to a corresponding MUD manager that includes at least one processor, and at least one memory coupled to the at least one processor and which includes computer readable program code that when executed by the at least one processor causes the at least one processor to perform operations. The operations are configured to receive using CoAP from an IoT device a URL advertising location of a MUD file stored in local memory of the IoT device, and to get content of the MUD file from the local memory of the IoT device using CoAP.

Some other embodiments are directed to a corresponding LwM2M server that includes at least one processor, and at least one memory coupled to the at least one processor and which includes computer readable program code that when executed by the at least one processor causes the at least one processor to perform operations. The operations are configured to receive a registration command from a LwM2M client for an IoT device using CoAP. The operations determine a policy to be used to control communications with the IoT device, and determine content of a MUD file based on the policy that is determined. The operations then provide the content of the MUD file to the LwM2M client for the IoT device using CoAP.

Some other embodiments are directed to a corresponding RD server that includes at least one processor, and at least one memory coupled to the at least one processor and which includes computer readable program code that when executed by the at least one processor causes the at least one processor to perform operations. The operations are configured to receiving a command from an IoT device to register a URL for a MUD file stored in local memory of the IoT device, and to store the URL as a MUD based resource type in an object structure maintained by the RD server. The operations respond to a query from an electronic device identifying the MUD based resource type by providing the URL to the electronic device.

Potential advantages of these and other embodiments disclosed herein include that by hosting the MUD file on the IoT device, the MUD manager is able to manage communication policies with the IoT device without needing to use an Internet connection to a remote MUD file server and, therefore, can operate during the absence of such Internet connectivity. Moreover, lower latency and higher reliable policy determinations can be made by the MUD manager communicating locally with the IoT device without relying on Internet connectivity to a remote MUD file server. The operational efficiency of the MUD architecture can also be improved by using CoAP to communicate contents of the MUD file from a CoAP server on the IoT device to a CoAP client on the MUD manager. Contents of the MUD file hosted by the IoT device may be effectively managed by a LwM2M server communicating with a LwM2M client on the IoT device. IoT devices can provide a Resource Directory (RD) server with URLs for locations of where the MUD files are locally stored at the IoT devices, and the RD server can then be queried by other electronic devices to discover which IoT devices have locally stored MUD files and to obtain the URLs of the MUD files.

It is noted that aspects described with respect to one embodiment may be incorporated in different embodiments although not specifically described relative thereto. That is, all embodiments and/or features of any embodiments can be combined in any way and/or combination. Moreover, other IoT devices, MUD managers, LwM2M servers, RD servers and corresponding methods and computer program products according to embodiments will be or become apparent to one with skill in the art upon review of the following drawings and detailed description. It is intended that all such other IoT devices, MUD managers, LwM2M servers, RD servers and corresponding methods and computer program products be included within this description and protected by the accompanying claims.

### BRIEF DESCRIPTION OF THE DRAWINGS

Aspects of the present disclosure are illustrated by way of example and are not limited by the accompanying drawings. In the drawings:

FIG. 1A is a block diagram of a MUD architecture;

FIG. 1B illustrates an example MUD process flow;

FIG. 2 is a block diagram of a MUD architecture for CoAP in accordance with some embodiments of the present disclosure;

FIG. 3 is a combined data flow diagram and flowchart illustrating a sequence of operations and data flows for MUD usage between various components of a MUD architecture in accordance with some embodiments;

FIG. 4 is a block diagram of an electronic node of a MUD architecture, e.g., IoT Device, a MUD Manger, and/or a LwM2M Server, containing elements that are configured according to some embodiments;

FIGS. 5 and 6 are flowcharts of operations by an IoT device in accordance with some embodiments;

FIGS. 7 and 8 are flowcharts of operations by a MUD manager in accordance with some embodiments;

FIGS. 9 and 10 are flowcharts of operations by a LwM2M server in accordance with some embodiments; and

FIG. 11 is a flowchart of operations by a Resource Directory server in accordance with some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of various present inventive concepts to those skilled in the art. It should also be noted that these embodiments are not mutually exclusive. Components from one embodiment may be tacitly assumed to be present/used in another embodiment.

Present MUD specifications have essentially no disclosure of Constrained Application Protocol (CoAP) nor Lightweight Machine to Machine Protocol (LwM2M).

The Constrained Application Protocol (CoAP) is a generic Representational State Transfer (REST) application Protocol for constrained devices, it is defined in RFC7252. CoAP is designed to be used over User Datagram Protocol (UDP) (RFC0768) over the Internet. CoAP variants like Lightweight Machine to Machine Protocol (LwM2M) are becoming increasingly popular in order to manage devices in a RESTful fashion.

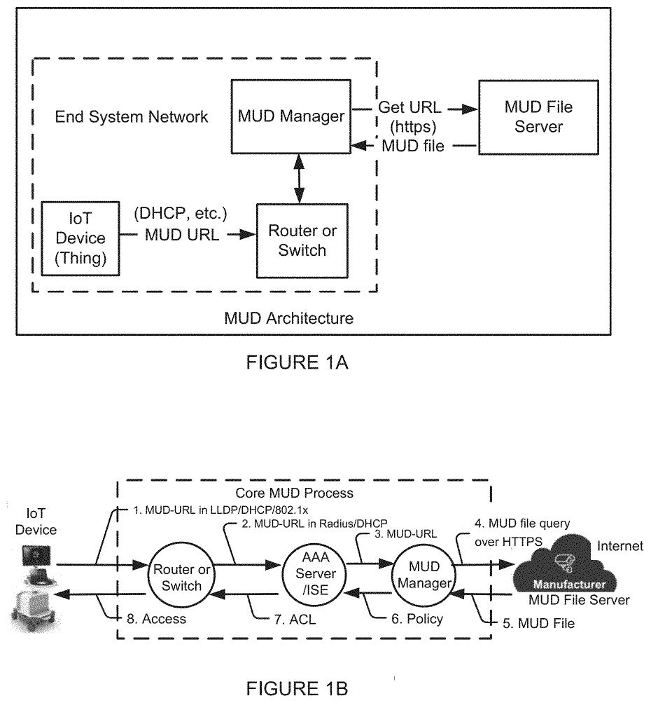

As explained above, FIG. 1A is a block diagram of a MUD architecture and FIG. 1B illustrates an example MUD process flow. In accordance with embodiments herein, MUDs can become a generic component of IoT devices which, like other components, need to be configured and managed. MUD URLs are using mandatory https. RFC7252 points out that
“A manufacturer may construct a MUD URL in any way, so long as it makes use of the “https” scheme.” Example: https://cisco.com/product_abc123/v5

The MUD URL is emitted using DHCP, LLDP or through 802.1X, then a network switch or network router will send the URI to some IoT Controlling Entity. That Entity will fetch the MUD file from a MUD file server through the Internet over HTTP [SECCONS].

This is not an ideal mechanism for CoAP endpoints. As shown above, MUDs have not been specified as exposed CoAP resources but rather as a URL to an external MUD file server shared over DHCP; exposing a CoAP “/mud” resource would be a more operationally efficient and robust solution than the current approach.

A CoAP device could expose both the URL and the MUD File that it is itself hosting.

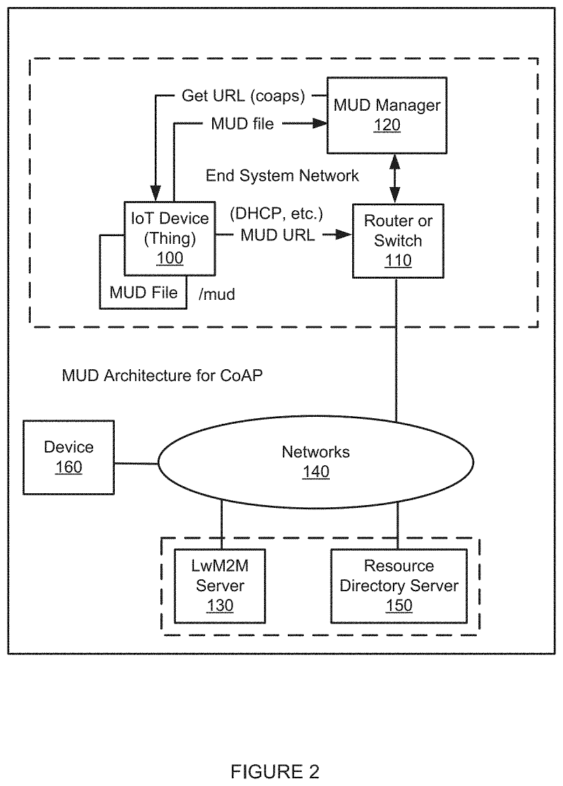

FIG. 2 is a block diagram of a MUD architecture for CoAP in accordance with some embodiments of the present disclosure. The MUD architecture includes an IoT device 100, a MUD manager 120, and a network router 110 or network switch 110 that communicates with networks 140 which may be one or more private or public network such as the Internet. The MUD architecture can also include a LwM2M server 130 and a resource directory (RD) server 150. In accordance with embodiments herein, the IoT device 100 locally stores and hosts the MUD file in its local memory. As will be explained in further detail below, the MUD manager 120 functions to fetch content of the MUD file from the IoT device, to validate the content of the MUD file, and responsive to proper validation then to provide the content to the network router 110 or network switch 110 to control communications with the IoT device 100. The LwM2M server 130 can function to manage, e.g. create and/or change, content of the MUD file stored in the IoT device 100. The IoT device 100 can communicate with the RD server 150 to register, e.g., POST, a URL for a MUD file stored in local memory of the IoT device 100. The RD server 150 can maintain a database containing a listing of IoT devices that locally store their MUD files and the URLs for those MUD files. An electronic device 160, e.g., a user equipment (UE), a server, etc., can query the RD server 150 to obtain a listing of URLs for MUD files stored at IoT devices.

Although the MUD Manager 120 is illustrated as being separate from the IoT device 100 and the network router 110 or network switch 110, functionality of the MUD Manager 120 may be at least partially implemented in another component of the MUD architecture, such as in the network router 110 or network switch 110, in the IoT device 100, and/or elsewhere. Similarly, although the LwM2M server 130 is illustrated as being separate from the RD server 150, functionality of the LwM2M server 130 and RD server 150 may be at least partially integrated into a common element.

The illustrated MUD architecture can be more a operationally efficient and effective design that may enable integration with the IoT network directly, allowing other IoT devices to also directly consume MUDs. This architecture may also allow easier integration with management protocols like LwM2M and provide resiliency in case Internet connectivity is not available in the constrained network.

Various embodiments of the present disclosure are directed to a MUD file being signed by the manufacturer, hosted in local memory of an IoT device, and exposed as a CoAP resource to enable such MUD usage on a managed network context.

Various embodiments are directed to mechanisms for devices to use MUDs in CoAP (Discovery, Reading, Verifying . . . ) and for integrating with other systems like the MUD manager (provisioning, update) and the manufacturer (signing) as well as other use cases with Software Updates.

In some embodiments, a CoAP server is configured to expose a new resource under, e.g., /mud. Making it available for CoAP Discovery so that other network elements can make use of it.

A MUD Object for LwM2M can be created using the LwM2M/IPSO model. In LwM2M a MUD Manager that processes the MUD can create an access policy with the information the IoT device is providing. Trust is ensured by way of certificates. The IoT device can also use the MUD to advertise the required Access Policies (see “from-device”). Various embodiments disclosed herein are directed to operations enabling devices to join the network and be configured to have a MUD and, if configured, can fetch the right policy and expose it.

Advantages provided by some or all of these embodiments may include any one or more of:
1. Enable reuse of MUD files, LwM2M and CoAP in accordance with operations herein;
2. Allow for devices to expose the MUD, thereby eliminating or reducing the need for a MUD File Server;
3. Open the MUD functionality to the CoAP ecosystem, thereby making it valuable for managed endpoints and for device to device interaction;
4. Allow MUD usage even without Internet connectivity; and
5. Use DHCP renew lease as an operation to advertise MUD changes.

Two different approaches are described below for the use of MUDs in CoAP.

A first approach is directed to Self-Hosted MUDs by way of CoAP. An IoT device contains a MUD file in local memory of the device and exposes its own MUD file over CoAP so that other network elements can make use of it. This approach may eliminate or reduce the need for use of a MUD file server. The IoT device exposes one or both of the MUD URL and the MUD file, and a Manager that processes the MUD can create an access policy with the information the device is providing. Trust may be operationally ensured by way of certificates used in communications. Moreover, as explained above, regarding FIG. 2, the IoT device 100 can communicate with the RD server 150 to register, e.g., POST, a URL for a MUD file stored in local memory of the IoT device 100. The RD server 150 can maintain a database containing a listing of IoT devices that locally store their MUD files and the URLs for those MUD files. An electronic device 160, e.g., a user equipment (UE), a server, etc., can query the RD server 150 to obtain a listing of URLs for MUD files stored at IoT devices. The electronic device 160 can use one or more of the URLs in the listing to obtain content of the addressed MUD file(s). The electronic device 160 may, for example, determine the communication capabilities or policy(ies) of an IoT device through the content of the addressed MUD file(s), and select among the IoT device for establishing a connection and/or to control communications therewith in compliance with the determined capabilities and/or policy(ies).

A second approach is directed to a management system providing a MUD configuration using LwM2M, consuming the MUD during registration, and configuring the IoT device accordingly. The system can have: a CoAP URL; the description hosted as a Resource; and discoverability using CoAP Discovery mechanisms.

The first approach directed to self-hosted MUDs in initially described below with reference to FIG. 2 which is a block diagram of a MUD architecture for CoAP in accordance with some embodiments of the present disclosure.

With reference to FIG. 2, the CoAP endpoint exposes a URL to the path “/mud” where it will host a manufacturer signed mud, it will thus fulfill the requirements of RFC8520. In the example of FIG. 2, a MUD file is exposed over CoAP “coaps://[IPv6]/mud”, with the basic configuration of the fact that IoT device is the one initiating the communication, so no inbound communication is allowed. Below is an example MUD-compliant description that makes use of CoAP and LwM2M, indicating to the LwM2M Server that all communication is device-initiated. The MUD-compliant description uses two non-limiting policy examples of a “from-device-policy” and a “to-device-policy.”

```
{
  “ietf-mud:mud”: {
    “mud-version”: 1,
    “mud-url”: “coaps://[IPv6]/mud”,
    “last-update”: “2019-10-11T11:02:20+04:00”,
    “cache-validity”: 48,
    “extensions”: [
        “ietf-mud-1wm2m-example”
    ],
    “ietf-mud-1wm2m-example:is-1wm2m-required”: “true”,
    “is-supported”: true,
    “systeminfo”: “An example thermometer”,
    “from-device-policy”: {
      “access-lists”: {
        “access-list”: [
          {
            “ietf-mud:direction-initiated”: “from-device”,
            “name”: “mud-87236”
          }
        ]
      }
    },
    “to-device-policy”: {
      “access-lists”: {
        “access-list”: [
          {
            “name”: “1wm2m-manager”
          }
        ]
      }
    }
  }
```

The MUD can be signed with the Public Key of the Manufacturer for verification purposes.

When using CoRE Link Format, a CoAP client can send a GET request to a CoAP server for /.well-known/core and get in return a list of hypermedia links to other resources hosted in that server. Among those, it will get the path to the MUD file, for example “/mud”. The CoAP server may, for example, be part of the Resource Directory (RD) server 150 and/or the LwM2M server 130 shown in FIG. 2.

A managed network approach with MUDs and discovering MUDs is now described.

Powered-on IoT devices should register a MUD file with the RD server and also use the RD server as a MUD file URL repository. The MUD file URLs become discoverable to other electronic device using known RD Lookup steps, such as by querying the RD server. These operations can provide a powerful discovery mechanism, such as the following example:

```
REQ: POST coap://rd.device.is/rd?ep=node1
  ct:40
  </mud>;ct=41;rt=“mud”
  </sensors/light>;ct=41;rt=“light-lux”;if=“sensor”
```

A new resource type (rt) can be created in order to enable MUDs to be used in the RD ecosystem. For example a request query for “rt=mud”:

REQ: GET coap://rd.company.com/rd-lookup/res?rt=mud

When querying for that resource type (rt=mud), the RD will return a list of links that host the mud resource, such as the example below:

```
RES: 2.05 Content
  <coap://[2001:db8:3::123]:61616/box>;rt=“mud”;
    anchor=“coap://[2001:db8:3::123]:61616”
  <coap://[2001:db8:3::124]/switch>;rt=“mud”;
    anchor=“coap://[2001:db8:3::124]”
```

Multicast may also be used to discover all Manufacturer descriptions in a subnet.

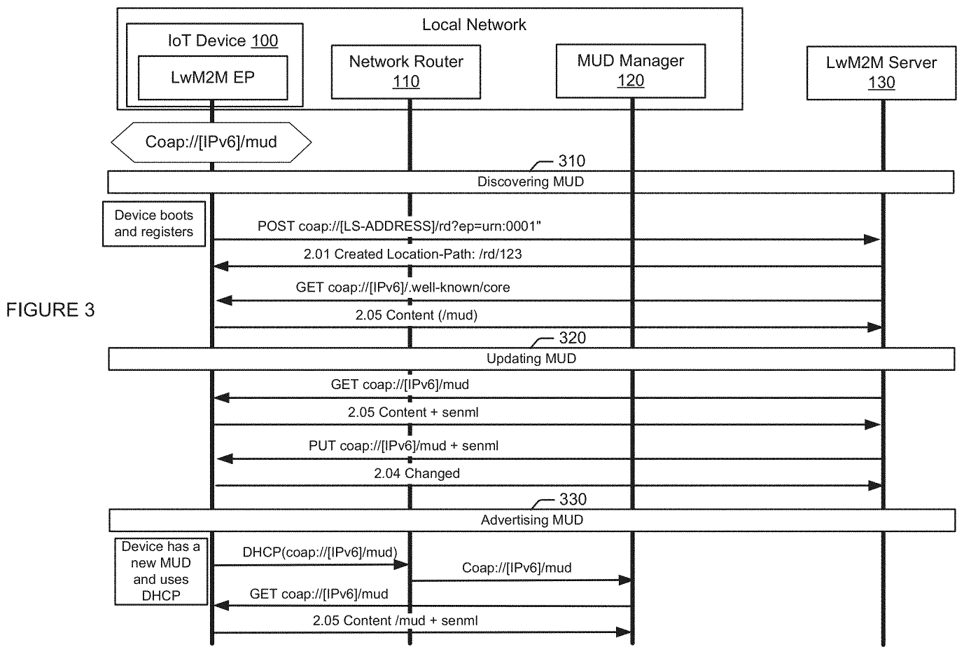

The second approach is directed to managed network with MUDs and LwM2M usage is described below with reference to FIG. 3 which is a combined data flow diagram and flowchart illustrating a sequence of operations and data flows for MUD usage between various components of a MUD architecture in accordance with some embodiments.

Referring to FIG. 3, operations and related communications are illustrated for a LwM2M End Point (EP) within the IoT device 100, the MUD manager 120, and the LwM2M server 130. The operations are grouped into operations 310 for discovering a MUD (e.g., contents of a MUD file), operations 320 for updating contents of a MUD file, and operations 330 for advertising a MUD file. When the L2M2M server 130 modifies content of the MUD file stored in local memory of the IoT device 100, the operations 330 can be repeated to advertise the modified MUD file to the MUD manager 120 to enable the MUD manager 120 to re-validate the MUD file and, when appropriate, generate new policy(ies) to control communications with the IoT device 100 through the network router (or network switch) 110. Although various arrows are used to convey example communication directions, the illustrated arrows are not limiting and the communications can occur in the opposite directions to those illustrated and may occur in both directions.

To use MUDs in LwM2M various embodiments map MUDs to the LwM2M Object structure. An example mapping between a MUD and a L2M2M Object structure is provided below.

| OBJECT: MUD | |
|---|---|
| +--ro MUD* [instance_number] | |
| +--rw instance_number | uint16 |
| +--rw mud_version | uint16 |
| +--rw mud-signature? | string |
| +--rw last-update | string |
| +--rw cache-validity | uint16 |
| +--rw manufacturer | string |
| +--rw model | string |
| +--rw from-device-policy | olink |
| +--rw controller | string |
| +--rw name | string |
| +--rw ace | string |
| +--rw to-device-policy | olink |

[...]
rw configuration data (read and write)
ro state data (read only)
x action

The above mapped Objects are a non-limiting example of a minimal MUD configuration in LwM2M for sake of brevity. The term “ro” refers to read-only allowed objects and the term “rw” refers to read-write allowed objects. In LwM2M the Controller can be a “urn:ietf:params:mud:coap” (the urn should be registered) and the two policy resources “from-device-policy” and “to-device-policy” point to two other objects that define the connectivity characteristics of the device. For simplicity, the embodiment adds three resources “controller”, “name” and “ace” (access control entry) consecutively.

Referring to the example embodiments shown in FIG. 3, a IoT device 100 registers the MUD object, i.e., content of the MUD file, on the LwM2M server 130, and the LwM2M server 130 applies a different policy (e.g., communication policy) on the IoT device 100 based on its characteristics. Lastly, the LwM2M client “LwM2M End Point (EP)”, will update the MUD and advertise it.

The content of the MUD file may be created during the Bootstrapping process by the Bootstrap Server or it may be predefined in memory by the manufacturer, e.g., at the factory. Either way during the registration the IoT device 100 using a MUD file also registers the MUD object. The IoT device 100 can perform a simple registration as specified in the Lightweight Machine to Machine Technical Specification: Core by the Open Mobile Alliance, OMA-TS-LightweightM2M_Core-V1_1-20180710-A, Version 1.1-2018-07.10.

In FIG. 3, the LwM2M server 130 and a LwM2M End Point (EP) on the IoT device 100 perform operations 310 for the LwM2M server 130 to discover the MUD file. For example, the IoT device 100 boots-up and registers with the LwM2M server 130 through a POST command A path for a rd is provided. The LwM2M Server 130 discovers whether this capability is available at the LwM2M Client (LwM2M EP). This is expected to be necessary because the capability might not be mandatory to implement.

A “GET” command provides a well-known core, and content of the MUD file is provided. The IoT device 100 returns a “2.05 Content” response with the contents of “/mud”, which in this case is the object “MUD”. Example code may be provided as follows:

| Interaction: LS -> LC | |
|---|---|
| Request: | GET coap://[IPv6]/.well-known/core (step 316) |
| Response: | 2.05 Content (step 318) |
| | </mud>;rt=“oma.1wm2m”;ct=110 |

The LwM2M Server 130 performs a GET operation on that particular object.

The IoT device 100 returns a “2.05 Content” response which may include the following SenML:

Int: LS -> LC
Req: GET coap://[IPv6]/mud (step 322)
Res: 2.05 Content
{“bn”:“/XXXX/0/”,
“e”:[
{“n”:“0”,“v”:“1”},
{“n”:“1”,“sv”:ManufacturerXYZ},
{“n”:“2”,“sv”:“2019-10-11T11:02:20+04:00”},
{“n”:“3”,“v”:“99”},
{“n”:“4”,“sv”:“ model-116”},
{“n”:“5”,“sv”:“X:X”},
{“n”:“6”,“sv”:“urn:ietf:params:mud:coap”},
{“n”:“7”,“sv”:“IP policy”},
{“n”:“8”,“sv”:“match-on-ipv4”},
{“n”:“9”,“sv”:“X:X”}]
}

The MUD Manager 120 queries its internal database with policies it has applied to that IoT device 100 or creates a new one. The policy is sent as a serialized MUD that edits the existing mud. If no MUD is present the MUD Manager 120 will use the existing Device Object to provide a default MUD on the IoT device 100.

The MUD Manager 120 performs a POST or PATCH operation to modify content of the MUD file. For example, the SenML below changes the endpoint to advertise the use of ipv4 only to ipv6.

The IoT device 100 responds with a “2.04 Changed” response to indicate a successful change of the parameter:

```
Int: LS -> LC
Req: PATCH coap://[IPv6]/mud
  {“bn”:“/XXXX/0/”,
  “e”:[{“n”:“6”,“v”:“match-on-ipv6”}]
  }
Res: 2.04 Changed
```

The IoT device 100 (endpoint) will update the “last-update” field at this point (the “n”:“2”) value and advertise the MUD file with a DHCP renew lease (new) and the new MUD URL. Otherwise the network could periodically update it according to a cache validity (value of 99) period.

Architecture network elements, such as a network router 110, will apply the MUD process and forward the URL to the MUD Manager 120.

The MUD Manager 120 will then query the IoT device 100 (endpoint) within the local network, which will provide the content of the current MUD file.

MUD file exposure to other network elements, i.e., other electronic devices 160 on the network, can be performed in the same fashion as the RFC specifies, and as explained above for discovering MUDs embodiments in operations 310. New mechanisms include IP multicast may be used with these embodiments.

In FIG. 3, the advertising MUD operations 330 may also be performed before the discovering MUD operations 310, e.g., upon power-up of the IoT device (Thing) and device booting-up and registering. The LwM2M EP (End Point), also referred to as a LwM2M client, shown in FIG. 3 would usually reside in the IoT device 100 but may reside elsewhere and communicatively connected to the IoT device 100.

Accordingly, various embodiments provide mechanism to configure content of MUD files for use in CoAP, which may be particularly beneficial for device environments without Internet connectivity and may operate better with the CoAP Architecture. These embodiments may improve current MUD usage by taking advantage of CoAP Servers, e.g., the LwM2M EP, which are running on constrained devices. These embodiments may introduce the usage in LwM2M, as well as the provisioning and MUD-signing mechanism.

Example components of an electronic node 400, which may be a IoT Device, a MUD Manger, a LwM2M Server, and/or a RD server described herein and shown in one or more of FIGS. 1-3, are described below.

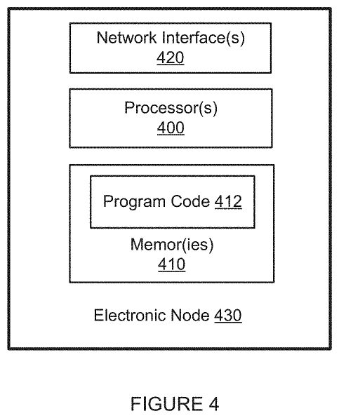

FIG. 4 is a block diagram of an electronic node 400 of a MUD architecture containing elements that are configured according to some embodiments. The electronic node 400 can include one or more network interfaces 420 (referred to as “network interface” for brevity), one or more processors 400 (referred to as “processor” for brevity), and one or more memories 410 (referred to as “memory” for brevity) containing program code 412.

The network interface 420 may be configured to communicate through a wired interface, e.g., Ethernet, and/or wireless interface, e.g., wireless transceiver, according to one or more proprietary protocols and/or industry standardized protocols, e.g., WiFi, Zigbee, Bluetooth, 3GPP 4G, 5G (NR), etc. The processor 400 may include one or more data processing circuits, such as a general purpose and/or special purpose processor (e.g., microprocessor and/or digital signal processor) that may be collocated or distributed across one or more networks. The processor 400 is configured to execute program code 412 in the memory 410, described below as a computer readable medium, to perform some or all of the operations and methods that are described above for one or more of the embodiments of an IoT electronic device, such as regarding one or more of the embodiments described herein, such as in the context of any one or more of FIGS. 1 through 3.

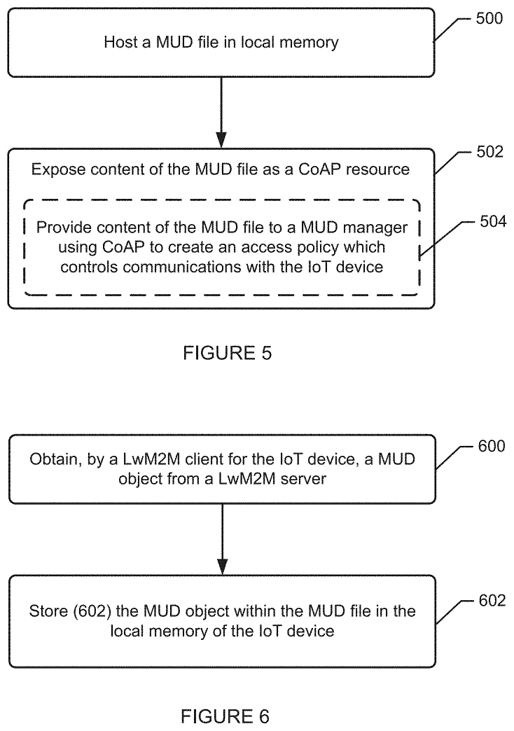

The above and more general operations and methods that can be performed by the IoT device 100, the MUD manager 120, the L2M2M server 130, and the RD server 150, are now explained with reference to FIGS. 5-11.

FIGS. 5 and 6 are flowcharts of operations by an IoT device 100 in accordance with some embodiments.

Referring initially to FIG. 5, the IoT device 100 can host 500 a MUD file in local memory of the IoT device 100. The device can expose 502 content of the MUD file from the local memory of the IoT device 100 as a Constrained Application Protocol (CoAP) resource.

In a further embodiment, the operation to expose 502 content of the MUD file from the local memory of the IoT device 100 as the CoAP resource, can include providing 504 content of the MUD file from the local memory of the IoT device 100 to the MUD manager 120 using CoAP to create an access policy which controls communications with the IoT device 100 through at least one of a network router 110 and a network switch 110.

In a further embodiment, the operation to provide 504 content of the MUD file from the local memory of the IoT device 100 to the MUD manager 120 using CoAP, can include providing a to-device-policy to the MUD manager which controls communications to the IoT device, and providing a from-device-policy to the MUD manager which controls communications from the IoT device.

In a further embodiment, the operation to provide 504 content of the MUD file from the local memory of the IoT device 100 to the MUD manager 120 using CoAP, can include: receiving, by a CoAP server on the IoT device 100, a CoAP GET command from the MUD manager 120; and providing, by the CoAP server on the IoT device 100 responsive to the CoAP GET command, the content of the MUD file to the MUD manager 120.

The content of the MUD file provided 504 to the MUD manager 120 may include a YANG-based JSON object describing network behavior for the IoT device 100.

Referring to the further embodiment of FIG. 6, the IoT device 100 may be further configured to obtain 600, by a LwM2M client for the IoT device 100 (e.g., LwM2M EP), a MUD object from the LwM2M server 130. The IoT device 100 can then be further configured to store 602 the MUD object within the MUD file in the local memory of the IoT device 100.

In a further embodiment, the operation to obtain 600, by the LwM2M client for the IoT device 100, the MUD object from the LwM2M server 130, can include: receiving resources defined in a LwM2M resource structure from the LwM2M server 130; accessing a mapping between the resources and MUD objects; and generating or updating the MUD file in the local memory of the IoT device 100 based on the MUD objects mapped to the resources received from the LwM2M server 130.

In a further embodiment, the IoT device 100 is further configured to respond to the generating or updating of the MUD file in the local memory of the IoT device 100, by providing content of the MUD file that is generated or updated to the MUD manager 120 using CoAP to create another access policy which controls communications with the IoT device 100 through the least one of the network router 110 and the network switch 110.

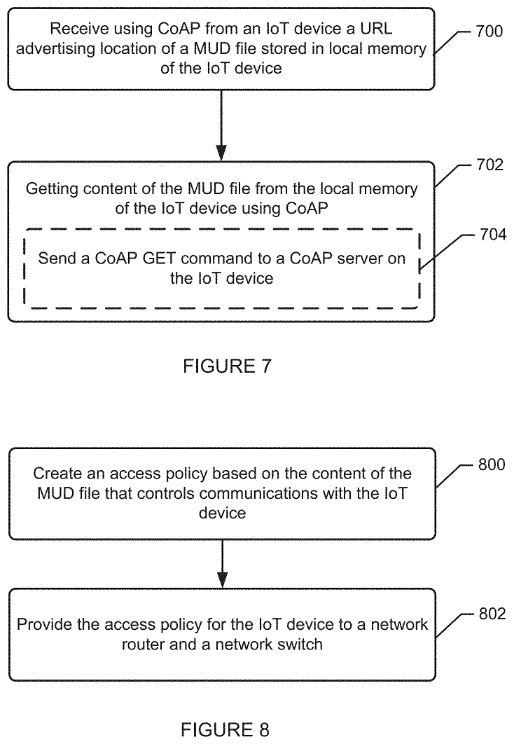

Various corresponding operations are to be performed by the MUD manager 120 are now described in the context of FIGS. 7 and 8.

Referring initially to FIG. 7, the MUD manager 120 can be configured to receiving 700 using CoAP from the IoT device 100 a URL advertising location of a MUD file stored in local memory of the IoT device 100, and to get 702 content of the MUD file from the local memory of the IoT device 100 using CoAP.

The operation to get 702 content of the MUD file from the local memory of the IoT device 100 using CoAP, can include sending 704 a CoAP GET command to a CoAP server on the IoT device 100.

Referring to the further embodiment of FIG. 8, the MUD manager 120 can be further configured to create 800 an access policy based on the content of the MUD file that controls communications with the IoT device 100 through at least one of the network router 110 and the network switch 110.

The operation to create 800 the access policy can include creating a to-device-policy that controls communications to the IoT device 100 through the at least one of the network router 110 and the network switch 110, and creating a from-device-policy that controls communications from the IoT device 100 through the at least one of the network router 110 and the network switch 110.

The MUD manager 120 can be further configured to provide 802 the access policy for the IoT device 100 to the network router 110 and the network switch 110.

The MUD manager 120 can be further configured to determine whether a certificate contained in the content of the MUD file is verified, and to only operate to create 800 the access policy to control communications with the IoT device 100 if the certificate is determined to be verified.

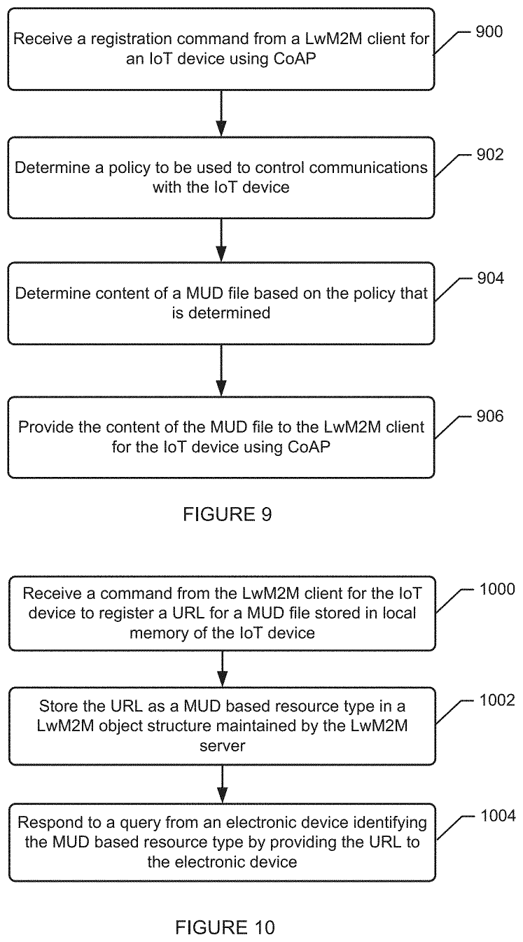

Various corresponding operations are to be performed by the LwM2M server 130 are now described in the context of FIGS. 9 and 10.

Referring initially to FIG. 9, the LwM2M server 130 is configured to receive 900 a registration command from a LwM2M client for the IoT device 100 using CoAP. The LwM2M server 130 is further configured to determine 902 a policy to be used to control communications with the IoT device 100, and to determine 904 content of a MUD file based on the policy that is determined. The LwM2M server 130 is further configured to provide 906 the content of the MUD file to the LwM2M client for the IoT device 100 using CoAP.

Referring to the further embodiment of FIG. 10, the LwM2M server 130 is further configured to: receive 1000 a command from the LwM2M client for the IoT device 100 to register a URL for a MUD file stored in local memory of the IoT device 100; store 1002 the URL as a MUD based resource type in a LwM2M object structure maintained by the LwM2M server 130; and to respond 1004 to a query from an electronic device (160 in FIG. 2) identifying the MUD based resource type by providing 1004 the URL to the electronic device. The command from the LwM2M client for the IoT device 100 may be received 1000 using CoAP. The URL may be received 1000 in a POST CoAP command from the LwM2M client for the IoT device 100.

The operation to provide 906 the content of the MUD file to the LwM2M client for the IoT device 100 using CoAP, may include providing a MUD object using a POST CoAP command or a PUT CoAP command The operation to provide the MUD object using the POST CoAP command or the PUT CoAP command, may include: accessing resources defined in a LwM2M resource structure of the LwM2M server 130; accessing a mapping between the resources and MUD objects; and generating or updating the MUD file in the local memory of the IoT device 100 based on the MUD objects mapped to the resources.

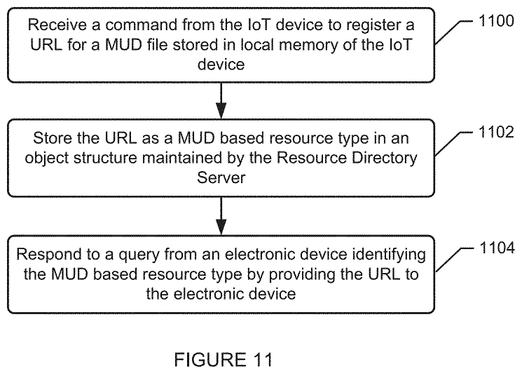

Various corresponding operations are to be performed by the RD server 150 are now described in the context of FIG. 11. Referring to FIG. 11, the RD server 150 operates to receive 1100 a command from the IoT device 100 to register a URL for a MUD file stored in local memory of the IoT device 100. The RD server 150 stores 1102 the URL as a MUD based resource type in an object structure maintained by the RD server 150. The RD server 150 responds 1104 to a query from an electronic device (e.g., 160 in FIG. 2) identifying the MUD based resource type by providing 1104 the URL to the electronic device.

In the above-description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

Various abbreviations used herein include the following:

| Abbreviation | Explanation |
|---|---|
| CoAP | Constrained Application Protocol, an IETF standard for |
| | a REST-based application layer protocol for the Internet |
| | of Things |
| LwM2M | Lightweight Machine-to-Machine, an OMA standard |
| IETF | Internet Engineering Task Force, a standards development |
| | organization |
| IoT | Internet of Things |
| MUD | Manufacturer Usage Description |
| OMA | Open Mobile Alliance, a standards development |
| | organization |
| RD | Resource Directory |
| rt | Resource Type |
| URL | Uniform Resource Locator |

1. A method by an Internet of Things, IoT, device, the method comprising:
hosting a Manufacturer Usage Description, MUD, file in local memory of the IoT device;
obtaining, by a Lightweight Machine-to-Machine, LwM2M, client for and in the IoT device, a MUD object from a LwM2M server; and
storing the MUD object within the MUD file in the local memory of the IoT device, and
exposing content of the MUD file from the local memory of the IoT device as a Constrained Application Protocol, CoAP, resource.

2. The method of claim 1, wherein exposing content of the MUD file from the local memory of the IoT device as the CoAP resource, comprises:
providing content of the MUD file from the local memory of the IoT device to a MUD manager using CoAP to create an access policy which controls communications with the IoT device through at least one of a network router and a network switch.

3. The method of claim 2, wherein providing content of the MUD file from the local memory of the IoT device to the MUD manager using CoAP, comprises:
providing a to-device-policy to the MUD manager which controls communications to the IoT device; and
providing a from-device-policy to the MUD manager which controls communications from the IoT device.

4. The method of claim 2, wherein providing content of the MUD file from the local memory of the IoT device to the MUD manager using CoAP, comprises:
receiving, by a CoAP server on the IoT device, a CoAP GET command from the MUD manager; and
providing, by the CoAP server on the IoT device responsive to the CoAP GET command, the content of the MUD file to the MUD manager.

5. The method of claim 2, wherein:
the content of the MUD file provided to the MUD manager comprises a YANG-based JSON object describing network behavior for the IoT device.

6. (canceled)

7. The method of claim 1, wherein the obtaining, by the LwM2M client for the IoT device, the MUD object from the LwM2M server, comprises:
receiving resources defined in a LwM2M resource structure from the LwM2M server;
accessing a mapping between the resources and MUD objects; and
generating or updating the MUD file in the local memory of the IoT device based on the MUD objects mapped to the resources received from the LwM2M server.

8. The method of claim 1, further comprising:
responsive to generating or updating of the MUD file in the local memory of the IoT device, providing content of the MUD file that is generated or updated to the MUD manager using CoAP to create another access policy which controls communications with the IoT device through the least one of the network router and the network switch.

9.-18. (canceled)

19. A method by a Lightweight Machine-to-Machine, LwM2M, server, the method comprising:
receiving a registration command from a LwM2M client for an Internet of Things, IoT, device using Constrained Application Protocol, CoAP;
determining a policy to be used to control communications with the IoT device;
determining content of a MUD file based on the policy that is determined; and
providing the content of the MUD file to the LwM2M client for the IoT device using CoAP.

20. The method of claim 19, further comprising:
receiving a command from the LwM2M client for the IoT device to register a URL for a MUD file stored in local memory of the IoT device;
storing the URL as a MUD based resource type in a LwM2M object structure maintained by the LwM2M server; and
responding to a query from an electronic device identifying the MUD based resource type by providing the URL to the electronic device.

21. The method of claim 20, wherein the command is received from the LwM2M client for the IoT device using CoAP.

22. The method of claim 20, wherein the URL is received in a POST CoAP command from the LwM2M client for the IoT device.

23. The method of claim 19, wherein the providing of the content of the MUD file to the LwM2M client for the IoT device using CoAP, comprises:
providing a MUD object using a POST CoAP command or a PUT CoAP command.

24. The method of claim 23, wherein the providing of the MUD object using the POST CoAP command or the PUT CoAP command, comprises:
accessing resources defined in a LwM2M resource structure of the LwM2M server;
accessing a mapping between the resources and MUD objects; and
generating or updating the MUD file in the local memory of the IoT device based on the MUD objects mapped to the resources.

25. (canceled)

26. (canceled)

27. (canceled)

28. An Internet of Things, IoT, device comprising:
at least one processor; and
at least one memory coupled to the at least one processor and comprising computer readable program code that when executed by the at least one processor causes the at least one processor to perform operations configured to:
host a Manufacturer Usage Description, MUD, file in local memory of the IoT device;
obtain, by a Lightweight Machine-to-Machine, LwM2M, client for and in the IoT device, a MUD object from a LwM2M server;
store the MUD object within the MUD file in the local memory of the IoT device, and
expose content of the MUD file from the local memory of the IoT device as a Constrained Application Protocol, CoAP, resource.

29. The IoT device of claim 28, wherein to expose content of the MUD file from the local memory of the IoT device as the CoAP resource, comprises to:
provide content of the MUD file from the local memory of the IoT device to a MUD manager using CoAP to create an access policy which controls communications with the IoT device through at least one of a network router and a network switch.

30. (canceled)

31. (canceled)

32. A Lightweight Machine-to-Machine, LwM2M, server comprising:
at least one processor; and
at least one memory coupled to the at least one processor and comprising computer readable program code that when executed by the at least one processor causes the at least one processor to perform operations configured to:
receive a registration command from a LwM2M client for an Internet of Things, IoT, device using Constrained Application Protocol, CoAP;
determine a policy to be used to control communications with the IoT device;
determine content of a MUD file based on the policy that is determined; and
provide the content of the MUD file to the LwM2M client for the IoT device using CoAP.

33. (canceled)

34. (canceled)

35. The IoT device of claim 28, wherein the computer readable program code when executed by the at least one processor further causes the at least one processor to perform the provide content of the MUD file from the local memory of the IoT device to the MUD manager using CoAP, by operations to:
provide a to-device-policy to the MUD manager which controls communications to the IoT device; and
provide a from-device-policy to the MUD manager which controls communications from the IoT device.

36. The IoT device of claim 28, wherein the computer readable program code when executed by the at least one processor further causes the at least one processor to perform the provide content of the MUD file from the local memory of the IoT device to the MUD manager using CoAP, by operations to:
receive, by a CoAP server on the IoT device, a CoAP GET command from the MUD manager; and
provide, by the CoAP server on the IoT device responsive to the CoAP GET command, the content of the MUD file to the MUD manager.

37. The IoT device of claim 28, wherein the computer readable program code when executed by the at least one processor further causes the at least one processor to obtain, by the LwM2M client for the IoT device, the MUD object from the LwM2M server, by operations to:
receive resources defined in a LwM2M resource structure from the LwM2M server;
access a mapping between the resources and MUD objects; and
generate or update the MUD file in the local memory of the IoT device based on the MUD objects mapped to the resources received from the LwM2M server.

38. The IoT device of claim 28, wherein the computer readable program code when executed by the at least one processor further causes the at least one processor to respond to generating or updating of the MUD file in the local memory of the IoT device, by providing content of the MUD file that is generated or updated to the MUD manager using CoAP to create another access policy which controls communications with the IoT device through the least one of the network router and the network switch.
